(19) United States
(12) Patent Application Publication
(10) Pub. No.: US 2012/0317059 A1
(43) Pub. Date: Dec. 13, 2012

(54) SYSTEM AND METHOD FOR SPACE AND RESOURCE OPTIMIZATION

(75) Inventors: Dinesh Govind Joshi, Thane (IN); Subhashis Nath, Bangalore (IN); Anupam Kulshreshtha, Bangalore (IN); Mahesh Huyilalu Shivaram, Bangalore (IN); Vinoop Aradhya, Bangalore (IN); Nagaraj Vijaya Kumar, Bangalore (IN)

(73) Assignee: Infosys Limited, Bangalore (IN)

(21) Appl. No.: 13/245,683

(22) Filed: Sep. 26, 2011

(30) Foreign Application Priority Data
Jun. 13, 2011 (IN) 1986/CHE/2011

(51) Int. Cl. G06F 15/18; G06N 5/02; G06N 5/00

(52) U.S. Cl. 706/12; 706/45; 706/47

(57) ABSTRACT

Methods and systems for space and resource optimization are disclosed, including a method comprising receiving a plurality of inputs, transforming the plurality of inputs into at least one or more of (but not limited to) an algorithmic graph and a structural graph based on a domain-specific area using a computer processor. The method further includes creating and applying heuristics for parallelization, performing an optimization run, and analyzing an optimal result produced by the optimization run.

### CROSS REFERENCE TO RELATED APPLICATION

This application claims the benefit of and priority to prior Indian patent application number 1986/CHE/2011, entitled “SYSTEM AND METHOD FOR SPACE AND RESOURCE OPTIMIZATION,” filed on Jun. 13, 2011, the entire disclosure of which is hereby incorporated herein by reference.

### FIELD

The present disclosure relates to resource optimization, including solving specific space and resource optimization problem.

### BACKGROUND

Space and resource optimization is a long-standing problem present across various fields such as inventory management, retail management, and other fields. Existing space and resource optimization techniques look at space as a single parameter of allocation and solve only the specific shelf space optimization problem. However, there exist several unsolved problems, such as being unable to recognize space-time as a generic continuum. Existing techniques treat micro space and macro space as two different problems, and do not contain the time dimension in the optimization process, leading to having only one frame in time of the micro space planogram. Because existing techniques are unable to treat constraints such as: inventory, supply chain, labor, presentation, assortment, portfolio, size and pack, budgetary, promotional and price variations, and other suitable constraints in planning as a single point of resolution, this leads to fragmentation of the planning problems into different optimizations problems such as inventory, price, supply chain, assortment, promotional, portfolio, macro and micro space optimizations with manual integration among them. Also, existing techniques are unable to recognize the spatial data in a way to reuse existing application infrastructure and have more context specific as well as context independent business constraints, rules for better macro or micro space, assortment planning. Business processes of merchandise planning, space planning is mostly manual for large numbers of retailers and store planning and merchandize planning processes and/or departments that are not fully integrated to give total life cycle support. Various kind of resources (e.g., time, money, and people) spent are phenomenal, and yet accuracies and productivities are mostly missing. Integration is mostly manual between various stages of planning and third-party tools, if it exists at all. Reuse of existing application in store planning, and merchandise planning from store layout and product placement are not accurately connected. Many intangible rules do not get captured or are manually adjusted for in the space planning processes. Correlation based rules remain untapped as data for them is not available easily; inflexibility of workflow management, business process scalability at lower level of execution; inability of existing applications to integrate store clustering as well as store planning as phases of planning with integrated views. Existing products do not have the ability to treat assortment plan, POG (point of gaze), floorspace plan, store plan, enterprise plan as consistent business entities and business documents and have a consistent strategy for their treatment, integration, view or management. The absence of integrated resource-asset management tool features to integrate the store plans, assortment plans and space plans and common information repository for various departments and implementation which will be a solution without replicating the information sources across department (having consistent, one source of entities, business documents, business processes across planning cycles for all roles: store planning, space planning, assortment planning, and/or enterprise merchandise planning) or having a data integrity issues with information or have non-consistent business processes. Current products do not provide an efficient, performing, automated, and easily context integral solution to process the amount of information during merchandising cycle. Current products do not provide space elasticity numbers to be able to decide on facings in optimizations.

Accordingly, there is an long unmet need for techniques that enable generic principles, approaches, frameworks, processes, techniques, and methodology to solve different kind of problems involving multi-dimensional, hierarchical, multi-objective optimization with distinct commonality abstracted and similarities generalized and in-process identifying common relaxations, assumptions, and approximations.

### SUMMARY

Aspects of the disclosure relate to solving space and resource optimization problems. The present disclosure describes exemplary methods that can be used to solve problems involving space, time, item entity dimensional hierarchies, and allow optimization of allocation selection problems under a variety of constraints and objectives.

According to the one aspect of the present disclosure, a method for space and resource optimization comprises receiving a plurality of inputs, wherein the inputs can be, but are not restricted to, reference data or user-provided constraints. The plurality of inputs is transformed to an algorithmic graph or a structural graph based on a domain-specific area using, for example, a computer processor. The plurality of inputs can be transformed based on an internal application or an algorithmic requirement. After transforming the plurality of inputs, they are unfolded onto a specific axis. Further, the plurality of data unfolded on the specific axis is encoded onto an S-cell structure axis. In some examples, the transforming the plurality of inputs also comprises transforming a plurality of decision variables based on a problem statement or an internal structure. The plurality of constraints can be transformed using a plurality of constraints such as: a plurality of relaxations, a plurality of approximations, or a plurality of assumptions. In some examples, the exemplar method also comprises generating a dynamic model from a plurality of objectives, where the plurality of objectives can be a single objective, a multiple objective or both. In some examples, an implicit constraint file and/or an explicit constraint file can also be generated. In some examples, heuristics are created for implicit and/or explicit parallelization. In some examples, the method further comprises an act of performing an optimization run. In some examples, a method comprises analyzing an optimal result from the optimization run. In some examples, analyzing an optimal result includes generating a set of decisions, at least one output dimension, or an optimal result from the plurality of decision variables.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures.

### BRIEF DESCRIPTION OF THE DRAWINGS

FIG. 1 is a flow chart illustrating a method 100 for space and resource optimization in accordance with an embodiment of the present disclosure.

FIG. 2 is a block diagram illustrating a system 200 for space and resource optimization, in accordance with an embodiment of the present disclosure.

FIG. 3 illustrates a generalized example of a suitable computing environment in which described embodiments, techniques, and technologies can be implemented.

### DETAILED DESCRIPTION

This disclosure is set forth in the context of representative embodiments that are not intended to be limiting in any way.

As used in this application and in the claims, the singular forms “a,” “an,” and “the” include the plural forms unless the context clearly dictates otherwise. Additionally, the term “includes” means “comprises.”

The systems, methods, and apparatus disclosed herein should not be construed as being limiting in any way. Instead, this disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Furthermore, any features or aspects of the disclosed embodiments can be used in various combinations and sub-combinations with one another. Furthermore, as used herein, the term “and/or” means any one item or combination of items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged, omitted, or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “receive,” “produce,” “generate,” “associate,” “select,” “search,” and “provide” to describe the disclosed methods. These terms are high-level abstractions of the actual operations that are performed. The actual operations that correspond to these terms can vary depending on the particular implementation and are readily discernible by one of ordinary skill in the art.

Any of the disclosed methods can be implemented with computer-executable instructions stored on one or more computer-readable storage media (e.g., non-transitory computer-readable media, such as one or more volatile memory components (such as DRAM or SRAM), or nonvolatile memory components (such as hard drives) and executed on a computer. Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially-available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, JavaScript, Perl, Python, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Theories of operation, scientific principles, or other theoretical descriptions presented herein in reference to the systems, methods, and apparatus of this disclosure have been provided for the purposes of better understanding and are not intended to be limiting in scope. The systems, methods, and apparatus in the appended claims are not limited to those systems, methods, and apparatus that function in the manner described by such theories of operation.

As will be readily understood by a person having ordinary skill in the art, the instant disclosure proceeds with references to the following terms and definitions.

Cellular computing includes computing techniques to simulate the workings of cells as can be used to solve a variety of problems or create systems that are self-driven and organic in nature.

S-cells (or stem-cells or) super-cells are constructs in a cellular computing paradigm that are a unit of computing used in cellular computing. S-cells can be thought of as the computing equivalent of a biological cell, for example, that functions of a super cell or stem-cell, which are the root of other cells. S-cells are cells that encapsulate core functionalities of domain in a similar fashion to the way a stem-cell encapsulates the core functionality of other cells of all other organs and develop into organs of different types. S-cells can contain attributes and transformed dimensional data which facilitates computing. Computing cells can be assigned different types and can have intelligence associated with them in form of, for example, algorithmic creators, translators or transmitters, and can provide communication facilities as with biological cells.

S-grids (or super grid) are organized collections of s-cells. Under an S-grid model, computing functionalities include creating, interpreting and transforming computing virtually into canvases or pictures made up of S-cells, for example, into large, multi-dimensional matrices encapsulating a domain structural taxonomy made from S-cells into the respective matrices, along with unfolding of hierarchical and dimensional data is called a super grid or simply S-grid. An S-grid can be thought of as an intelligent organic digitization of multi-dimensional multi-hierarchical virtuality (a motion picture of a computing world).

S-graphs (or super graphs or super assemblies) are similar to s-grids, but as an S-graph computational universe is made from a hierarchal assembly or a super graph, it has similar properties of S-grid as well as its own intelligence. S-graphs can be thought of as having organ functionality composed of a number of different cells or body functions using variety of these organs. Just as a body itself has different multitude of functions which use organs; we can say that bodies have survival or growth functions, just as a cells making up a body have survival and growth needs. We can also infer that a body has a free will and other set of desires which are somewhat missing in simple cells. A cell can be thought of as body in itself at lower scale.

Seed computing is a computing paradigm that involves patterns which simulate or mimic a number of seeds planted in a field. Just as one would drop certain seeds over a field to cover the field, tactical locations for dropping seeds will be selected to avoid overlaps. In computing, a field is replaced by a digital canvas of a solution universe, where seeds are locations and algorithmic, and which will start growing (solving) the digital canvas for solutions. One can drop many seeds within the solution universe to divide and conquer the problem as fast as possible. Each computing seed can commence growing in one or many directions to traverse a possible solution space and arrive at one or many possible candidate solutions. Hence, seed computing uses parallel, grid, and cloud computing along with divide and conquer techniques to solve problems much faster. Each cell “grows” independently in its area of the canvas, so seed dropping algorithm should be applied in consideration of the features of the solution universe as well as its size, computing resources available, and to avoid overlapping seeds. Seeds which intersect or overlap could terminate the germination of both the computing seeds and may involve reduced utilization of the computing seed, just as in the real world where placing seeds for two trees side-by-side can result in either or both trees perishing consuming one other. Thus, redundant computing is avoided due to possible overlap between seeds or to keep the redundant computing only to boundary areas (as much as possible) and have a well-balanced, well-divided (in some examples, equally divided) solution universe for distributed or dropped seeds and to have maximum effect and smallest possible execution time to cover a solution space.

Symmetric computing includes computing patterns which can be used to create or harness structural or processing symmetry of a computing context and its entities to derive significant benefits in enriching the base computing capacity of a computing system framework and/or system throughput. Symmetric computing patterns can exploit structural or behavioral symmetries of a problem or solution universe to improve solution or computing time.

Enterprise computing patterns, techniques, and tools work as whole at the enterprise level and enable computing to happen at various levels by effectively provides enterprise functional hierarchies and smooth or seamless integration. Alternatively, enterprise computing can be conceived of as patterns or computation which brings effectiveness in resource utilization and demand by facilitating efficiency and improve the return on IT. As another alternative, enterprise computing can simply be a term for usage of enterprise software tools and creating enterprise-wide computational platforms.

Chain reaction computing includes computing patterns which mimic chain reaction and can quickly spread and consume a solution space. Chain reaction computing act over computing seed and grow rapidly in all directions to create computational graphs of problem and solution universes. A chain reaction paradigm is primarily used to improve the computing time of large computational problems by breaking down a problem-solution universe and executing the sub-problems or exploring the sub-solution universe for quicker completion.

Avatar computing includes computing phenomenon, computing needs, and techniques where optimal selection, placement, and distribution of entities (from a variety of groups) and variations inside a container with application of particular contextual rules. Entities can form various avatars, and an avatar is selected to manifest in a container in some form.

Logical or virtual products allow the ease of approximations in computing algorithms as well as the ease of merchandising to retailers that use the disclosed technologies. Logical or virtual products are essentially made up of one or many products and behave as a single atomic unit of merchandising.

Avatars are a specific representation of a product on a shelf. By recognizing and identifying various ways retailer can decide to arrange products on a shelf (e.g., sometimes as a group of products, sometimes rotated, sometimes stacked on top of one another or side-by-side), various manifestations of products as avatars in a retail world can be realized. Various computing techniques can be used to create optimal fitting of such products with their avatars on a shelf and a fixture.

Avatar for facings can be defined. By facing a number of physical products placed side-by-side and exposing the face of each product on a shelf to a consumer for selection, variations in how many products, of which types and whether the products should be kept side-by-side, in what quantity, and in what store is a complex, domain-intensive choice which uses functional structures such as decision trees. One form of avatar can be defined as representing products with an optimal number of facings out of a number of choices on a shelf.

Avatars for displaying product rotation and/or product placement on the shelf can also be defined. For example, a retailer can choose to keep certain products with their facings as rotated product in particular way on a shelf. This placement can be selected for space saving, space utilization, or for proper representation (e.g., books on a shelf). For example, 6 different configurations in which product can be placed on the shelf can be defined and termed rotational avatars of the product.

Avatars of product stacking are manifestations of a product which involve stacking products of similar or different types on top of one another based on presentation strategies, assortment, inventory, and/or space are called “stacking avatar” as used herein in regards to retail merchandising

V-avatars are avatars of logical or virtual products. V-avatars can involve one product or groups of products such as logical or virtual products behaving as single atomic unit.

All of the above distinctive variations of a product possible in its universe will be called the super avatar of a product.

God-avatar (or G-avatar) are a generic abstraction of the concept of an avatar as applied to any entity in its generic universe. All concepts that are applicable to retail as avatars are also applicable to generic allocation of any entity type in space, or to be more general, to any entity which is a contained in its container for selection, placement and distribution. In some examples disclosed herein, God-avatars can be used as generic placement mechanisms.

The terms Zero- or one-click indicates the level of automation, intelligence, and/or usability aspects of the solution such that merchandisers can easily configure rules, constraints, and/or templates to create merchandise plans with the receipt of one or no clicks (e.g., mouse blocks) and without any manual entry or re-work.

The term “integrated” refers to assortments, Macros, Micros, and other suitable tie-ups such as inventory, pricing, and/or budget.

Merchandising hierarchy can be correlated to space hierarchy to tentatively and recursively find levels of optimization.

Macro-Space, Micro-Space, budget, assortment, inventory, promotions, price can be simultaneously sized and packed in supply chain optimization.

Round trip refers to continuous feedback with versioning of entities and automatic intelligence incorporated.

Micro Plan-o-grams, floor space plans, assortment plans, budgets, and inventory plans can be automatically created using intelligence from rules and templates with customization per season, per cluster, and/or per store.

The use of intelligence and optimization techniques can be used to create optimal merchandise plans such as plan-o-grams (POG), floor plans, assortment plans, budgets, and inventory plans.

### Example Space and Resource Optimization Method

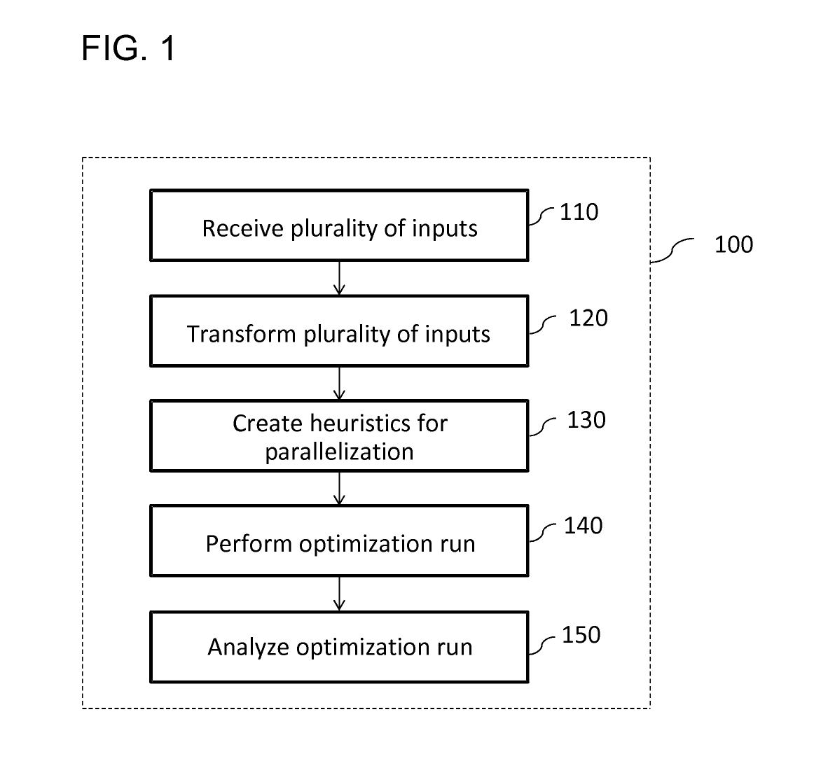

FIG. 1 is a flow chart 100 that outlines an exemplary method of space and resource optimization as can be used in accordance with certain embodiments of the disclosed technology.

At process block 110 a plurality of inputs is received. The plurality of inputs can be, but not restricted to, at least one dimension, reference data, at least one hierarchy, a plurality of user provided constraints, or a combination of these inputs. At least one hierarchy can be present inside each of the at least one dimensions defined as an input. After the plurality of inputs received, the method proceeds to process block 120.

At process block 120, the plurality of inputs received at process block 110 is transformed into at least one or more of an algorithmic graph or a structural graph. In some examples, the plurality of inputs is transformed based on an algorithmic requirement or based on an internal application. At least one hierarchy present inside one or more of the dimensions is unfolded on a specified axis. Further, the plurality of data is encoded on the specified axis in an S-cell structure axis. The plurality of data on the specified axis in the s-cell structure axis is then solved. A plurality of decision variables can also be used while transforming the plurality of inputs. For example, the plurality of decision variables can be a problem statement or an internal structure. Also, a plurality of constraints can be used for the act of transforming the plurality of inputs. The plurality of constraints can be, but are not limited to, a plurality of relaxations, a plurality of approximations, and/or a plurality of assumptions. The act of transformation can also be performed using the plurality of user inputs, wherein the plurality of user inputs can be, but are not limited to, a set of domain-specific rules and/or a set of domain-independent rules. Transformation can be performed at a higher level constraint type into lower levels constraint types by subsequent application for each higher level or extended constraint type into its respective relevant lower level constraints and then further be converted into base or atomic constraints.

In some examples of the disclosed technology, structural simplifications are performed after the transformation of the plurality of inputs. The structural simplifications can be enforced by, for example, an implicit constraint. After transforming the plurality of inputs, the method proceeds to process block 130.

At process block 130, heuristics are created for parallelization. The heuristics can be for both implicit and explicit parallelization.

At process block 140, an optimization run is performed on the transformed plurality of inputs produced at process block 120 using the heuristics created at process block 130. When optimization runs, an optimal picture that is rendered (e.g., a nonlinear or linear multi-dimensional or multiple objective) that points on a portion of the internal canvas representing optimality. For example, an internal picture or structure is set equal to the transformations plus implicit-explicit domain specific and domain independent structural constraints plus explicit domain picture constraints plus implicit domain picture constraints, and the algorithm is simulated by creating a structure inside an optimization. After performing the optimization run, the method proceeds to process block 150.

At process block 150, an optimal result that was generated from the optimization run is analyzed. While analyzing the optimal results from the optimization run, a set of decisions, at least one output dimension, or an optimal result from the plurality of decision variables are generated either in combination or individually. Furthermore, a post-transformation or reverse transformation is performed after analyzing the optimal results. Transformation is specific to a particular problem type and algorithm and is created as a picture of the source or target universe of feasible solutions. The picture is made up of cell-like pixels, super-cell, and/or organisms, or can evolve like stem cells into any definite organ, where an s-cell encodes information with respect to dimensional data, hierarchical data, and/or objective function data as a combined decision variable, to transform the inputs to fit into the respective structure.

As appreciated by a person having ordinary skill in the art, the concept of S-cell can be defined by defining S-cell as a encoding of information of multiple dimensions and hierarchies into the S-cell. By defining such S-cells, different structures (assemblies or graphs of S-cells encapsulating properties of domain objective function, along with domain entities) can be created statically or dynamically to facilitating mimicking different algorithms or to generalize different problem statements. Structures of an s-cell are enforced by the use of generic or specific constraints of association of multi-dimensional entity-hierarchies and by unfolding on an internal axis where the structure is established, thereby reflecting either the generic, aggregate, or higher resolutions of problems statements. For example, we can define an S-cell as a whole or part of a decision variable which has a cell x-component, y-component and z-component, where:

cell x component=Transform(dimension1.hierachy_{1-Node}, . . . , dimension1.hierarchy_{n-Node})

cell y component=Transform(dimension2.hierachy_{1-Node}, . . . , dimension2.hierarchy_{n-Node})

cell z component=Transform(dimension3.hierachy_{1-Node}, . . . , dimension3.hierarchy_{n-Node})

An objective function can be defined by a maximizing function of, for example, Profit, Rank, or Multiple Objectives as a sum of all S-cells, S-cells in frame, and/or decision variables.

Thus, a specific S-cell part of an internal picture or point of optimality becomes a yes/no decision variable either set implicitly (an implicit constraint) or set by an optimization run at the output based on the achieved optimality.

Methods described in the present disclosure can be better explained when acts in the described method are used to find out optimal set of products to be carried in an assortment for a typical retail store, at a micro level. More particularly, the described methods can be used as an approach for determining a possible location for the selected assortment, to assess the impact of varying product margins on the potential assortment, to decide upon the number of facings required to be carried by the retailers in case elasticity (variation in sales due to variations in facings, and unit change in profit/revenue as we change the space allocated to it per store-cluster-season) are considered. Some of the disclosed methods can be used derive the useful space elasticity substitutes in computing the optimality at Macro (e.g., department or category) levels. The disclosed technology can also be used to arrive at proper specializations of Macro/Micro plans by applying and/or creating business intelligence scenarios, what-ifs for various parameters, to derive further demographic-sensitive contextualized planograms or floor plans at a cluster, individual store, fixture, or zone levels.

In some examples, micro-planning can be performed using at least one or more of the following: inventory, presentation, assortment, pricing, budget, and supply-chain replenishment rules and case pack size to determine facings, thereby reducing optimization to a knapsack-like problem. Facings, minimum and maximum limits, along with product instances (avatars) can be used to handle elasticity. Consumer decision trees can be used to limit the number of products that meet the same demand.

In other examples, the macro planning level optimization can be performed by using the concept of 720 degrees of sensitivity analysis from micro stage to compute space, location, and/or cross elasticities to be used at macro level. 720 degrees business super senselligence is an advance sensitivity and spherical sensitivity gradient analysis, is analysis, or what-if anlaysis around all key decision variables, parametric variations, inputs variations possible in a problem universe to provide likely changes in the inputs to arrive at specified o/p values, e.g., to create a guidance system in a form of an advance decision sphere for relevant data inputs and changes in levers as well as variations in merchandise strategies for creation of optimal POGs, assortment sets as tuned to context, demographics, season and cluster. Per cluster, per store, and/or per season avatars for departments, categories and subgroups can be used. Variations in terms of allocation of space and equivalent variation in expected sales and expected average margins aggregated for subgroup, categories, and departments can be used to drive space allocation to department and/or categories and subgroups for specific group of stores and store per season.

Additional business process features that can be used for retail merchandise and space planning is zero or one-click, integrated, hierarchical, simultaneous, and/or round trip with automation and optimality.

In some examples of the disclosed technology, a sample minimalistic model for micro space can be used as one of the base models that are created with relaxations and assumptions for improved performance and feasibility based on one or more of the following assumptions:

model without stacking, rotations of the products inside the shelf;

facings variations being implemented as an avatar;

single objective function for rank and profit;

simple linear objective and no non-linear objective;

elasticity to be used (e.g., linear model);

an assumption that product is being stacked behind its facing by the same product;

do not elaborate on height and depth constraints as equations;

equal shelf width;

shelf and section/fixture as a rectangular entity only; and

ignoring implicit loss of space due to fixturing components.

In some examples of the disclosed technology, constraint types are defined as templates (including composite templates), which are used by merchandisers to create constraint instances that are dynamically converted into model equations as a part of dynamically generated model and then sent to optimization with relevant input data to create an optimality state.

Aspects of the disclosed technology also propos a simple and effective technique for identifying various constraint types needed. The constraint types can be used in Micro space planning optimization, and essentially creates a permutation and combination around key entities and decisions involved in the optimization of space. Some of the parameters which act as an input to constraint type creators and identifiers are as follows. This technique essentially de-normalizes, flattens, and/or expands the constraint types. By using an expanded constraint type instead of normalized or abstracted constraint, it is easier to manipulate by the end user or merchandiser of a retailer. The selection-relation constraint type family can comprise one or more of the following:
Item(s) Must|Must Not be Selected (e.g., from groups);
Item1(s), Item 2(s) Must together|Must Not be Selected together (e.g., from groups);
Selection-Relation Constraint Types Family;
Item(s) Must|Must Not Be selected based On a <condition> from Item Group; where the condition can be less than or equal to, less than, equals, greater than, or greater than or equal to;
Item can only be selected with x number or fewer facings; and
Item can only have one or many possible rotational configurations.

The positional-relational type constraints family can comprise one or more of the following:
Item(s) Must|Must not be on shelves (#) (if selected);
One or many from Item1(s), one or many from Item 2(s) Must|Must Not be together on shelves/Levels/Z-indexes;
Item(s) Must|Must Not be on shelves and/or location(s)/Levels/Z-indexed;
Item must be|Must Not be in particular vicinity—neighborhood (logical and physical neighbors) of shelf or location/Levels/Z-indexed groups or other items; and
Item Must|Must Not be at exact physical coordinates.

Both of the above embodiments can be combined, mixed, or grouped to create variety of possible constraint types. Moreover, only a few types have been enumerated out of a number many possible types.

The example disclosed above depicts various constraint types for micro space planning that could be created involving item, item and shelf (both in singular or plural). For example, one constraint type could be “Must selection of the item” or could be “Must placement of the item to shelf,” among many constraint types. Different combinations of constraint types can be data-mined, and then shortlisted and the important constraint types prioritized, researched, and modeled those in micro or generic space planning. The number of possible relevant permutations and combinations creating a unique de-normalized constraint types are many. The example constraints described above can be generalized and applied to generic space-time by substituting an entity from a dimensional hierarchy in place of the item.

In some examples of the disclosed technology, a Micro, Macro, business constraints and/or management-constraint editor includes the ability provided to merchandisers to create a dynamic business constraint and/or rule instance to act as an input to specific runs of POG optimization. During this stage, intelligence gets converted into a dataset to be inculcated into an optimization process and generate cluster, store, fixture, and/or product specific optimized planograms. This acts as a decision input to a primary optimization and is a user friendly module to be used by end users such as a buyer-merchandiser.

In some examples of the disclosed technology, the Micro or Macro, visual POG/floor plan constraint pattern recognition, data-mining, and extraction has the ability to create or mine constraints and business rules automatically from existing data such as POG, floor plan or POS sales.

In another embodiment of the present disclosure, a Micro or Macro CDT creation module provides the ability to merchandisers to create guiding principles for consumer decision trees and the automatic creation of constraints and rules based on priorities as well as auto and manual Business Linkage, including the ability to reconcile, link the business documents and entities such as assortment plan, set, POGs, fixtures, stores, clusters with meaningful linkages with various documents and their versions.

A sample pseudo code for micro space planning avatar in addition to all content on avatar can be performed as disclosed below:
1. Allow retail merchandisers to create valid “Avatars” of the products: per season, demographics, or cluster.
2. Allow retail merchandisers to specify different sales measures or rank per avatar of the product.
3. Treat avatars as a single internal dummy product being mapped to external product having the facings x width or as per that avatar of the product.
4. Allow merchandisers to use these avatars of products in Input data, what-ifs, and for optimization or as input argument to constraint types.
5. Generate a set of avatar-specific constraints with additional special constraints to only choose one (e.g., and not more than one) of the possible avatars of the products. This allow the optimizer to prefer an avatar which maximizes the objectives with constraints to ensure that a basic premise of allowing only one product instance with most appropriate facings to be on a particular shelf.
6. Create optimal versions of the planogram, with generating avatars seamlessly for products (e.g., transforming real product to internal dummy product and transform back as needed)

In some examples of the disclosed technology, solving problems of retail shelf space optimization can include integrated-simultaneous retail assortment, macro and micro space and inventory planning, which can be solved by representing general information on x, y, z axes in conjunction with a real or binary output indicator and an objective function value that represents the basic structure. The size depends upon logical associations and logical constructs which make the S-grid, along with constraint maps that are created as additional data restricting cell association to its space. The input can be in the form of store clusters/stores and attributes products/categories/groups, attributes fixtures/sections, attributes stores/floor plans, association hierarchies and attributes, between store clusters/stores, floor plans, fixtures, products, constraint-rules, association fixture-presentation, and assortment inventory rules hierarchy demand data. When these inputs are transformed as described above regarding the method of FIG. 1, outputs generated can include but are not limited to, 2D-3D-location-space-hierarchy, product, time map assortment, time map profit maximization, thereby increasing revenue and increasing the return on space.

In another embodiment of the present disclosure, generic domain-independent space optimization can be achieved by accepting one or more inputs of generic space structure across which an entity is to be allocated, selected, an assorted generic entity structure to be allocated, generic attributes of entity and space, generic constraints associating with an entity/or its attributes with respect to space, generic constraints associating an entity with other entities or their attributes, generic constraint associating spaces with other spaces or their attributes, generic constraints associating entity groups with other entity groups and representing general information on x, y, z axes in conjunction with real or binary output indicators and objective function value representing the basic structure. Size depends upon its logical associations and logical constructs which make the S-grid, along with constraint maps that are created as additional data restricting cell association to its space. The generated output can include by is not limited to: 2D-3D-Location-allocable space hierarchy, allocable entity, and time (optional) map selection assortment-time (optional) list.

In other examples of the disclosed technology, a generic domain-independent multi-dimensional, multi-hierarchical optimization can be solved by accepting entity dimension equal to entity dimension plus entity hierarchy and time dimension equal to time dimension plus time hierarchy and association hierarchy between space hierarchy. Entity hierarchies are additional inputs along with the hierarchies themselves, and an objective function can also represent a hierarchical function. After accepting the inputs, the general information is represented on x, y, z axes in conjunction with a real or binary output indicator and an objective function value represents the basic structure. Size depends upon its logical associations and logical constructs which make the S-grid, along with constraint maps are created as additional data restricting cell association to its space.

In other examples of the disclosed technology, by performing the acts described above regarding FIG. 1, the following problems can be solved.

Techniques for cargo-container space optimization can be solved using the disclosed methods, including: placement of items inside the container and container inside a cargo ship for efficient placement, retrieval considering logistics cost and distribution network costs as well as product, container size, associativity, temperature or pressure considerations can be solved by, accepting inputs such as cargo container ship, allocable space attributes and ship attributes cargo container product-source and destination attributes; route-address data and attributes, cargo container source and destination storage capability, attributes and data, things; Products/Categories/groups and attributes, container-Fixtures(logical)/Sections(logical) data and attributes, cargo ship level/ship-Floor Plans-Association hierarchies and attributes between cargo ship space clusters, floor-ship plans, fixtures, things-products, port data-route data, route data, source supply data and/or things-products and destination demand data and/or thing-products, shipping yard and ship labor, shipping yard constraints, product movement cost data, product storage cost data, product fragility cost risk data, product shipping-supply data; product demand data at ports, constraint-rules association for fixture-product containment; level-section, container-container association, container size restriction, contain type restrictions; and inventory, route, destinations rules hierarchy.

Techniques for warehouse space and inventory optimization can be solved using the disclosed methods, including: allocation of items, carton and boxes into 3-D space for efficient placement, retrieval and logistics of distribution with maximizing space utilization and minimizing movement and logistics costs by accepting inputs, warehouse clusters/warehouse dimension and attributes, products/categories/groups and attributes, fixtures/sections and attributes, warehouse level/floor plans; association hierarchies and attributes, between warehouse clusters; store clusters associations, stores, floor plans, fixtures, products, store-warehouse-entity demand data, labor constraints, product movement constraints and costs, constraint-rules and Association fixture-presentation-assortment; and inventory rules hierarchy demand data both cluster and warehouse.

Techniques for office space optimization can be solved using the disclosed methods, including: allocation of space to various projects and associated team members or departments across various office space structures while keeping in mind logistics, security, proximity, associativity, and isolation aspects of allocation by accepting inputs related to projects, segment teams data, departments data, employee master, and roles data, as well as seating floor plan data, space, project, departmental constraints, and employee constraints

Techniques for budget-portfolio optimization can be solved using the disclosed methods, including: allocation of limited funds to various portfolios which are distributed across departments or tracks (e.g., cost-risks-returns maximization on portfolio) by accepting inputs related to budget data, portfolios, and categorization data (available data), portfolio risk and returns data-functions (e.g., return-time function or risk function), budget, and portfolio-category constraints.

Techniques for project funding selection can be solved using the disclosed methods, including: selection, allocation of funds to various types of projects inside and across large multinational organization (e.g., risks, costs, and return maximization on projects) by accepting inputs related to project cost-return-risk data, project type, and attribute data projects data including hierarchy, funding data, fund groups data, fund availability data, fund allocation hierarchy data fund constraints, projects constraints, and project category constraints.

In some examples of the disclosed technology, retail merchandisers can define avatars of the product or use normal products themselves for performing some or all of the following acts. The retail merchandisers are allowed to create valid “Avatars” of the products-per season, demographics, or cluster. Further, the retail merchandisers are allowed to specify different sales measures or rank per avatar of the product. Also, the avatars are treated as single internal dummy product being mapped to external product having the facings x width or as per that avatar of the product. The merchandisers are allowed to use these avatars of products in input data, what-ifs and for optimization or as input arguments to constraint types. Furthermore, generating avatar-specific constraints with one additional special constraint to only choose one (and not more than one) of the possible avatars of the products can allow an optimizer to prefer the one which maximizes the objectives with constraints. This ensures that our basic premise of allowing only one product instance with most appropriate facings to be on the shelf is enforced. Later steps involve creating optimal versions of the planogram with avatars seamlessly of products (e.g., transforming real product to internal dummy product and transform back as needed).

In some examples of the disclosed technology, certain constraints and relaxations can be applied. Some of the constraints and relaxations include, but are not limited to:
Same products goes behind in the facing
Same product goes beside as one facing
Same product goes above as one facing
Same height product goes on same level
Same width product goes on same level
Same depth product goes on same level
Same height×width product goes on same level
Same height and depth product goes on same level
Same depth and width product goes on same level
All products with all its facing is one logical product
Each product can only be selected once
Empty space is null product of different variable length×width and depth
One product can span many space cell or one product can be allocated only to one space cell
All products can be rectangularized to nearest shape in 2-D or 3-D
Products cannot be arranged on top of one another
Products which has to be arranged on top has to have lesser width than bottom product
Products can be rotated only in some of allowable ways for the best fit out of all possible arrangements resulting into new length×width and depth.

In some examples of the disclosed technology, the space cell approximation strategies include:
One cell can be one location or one location is made of many cells
One location is occupied by one logical product
Number of locations horizontally cannot be greater than the shelf width or minimum size of logical or physical products
Number of levels cannot be greater than the shelf height divided by a minimum height of the logical or physical product
All cells are orthogonal in nature and all cell walls are parallel to container-shelf
All locations cells at one level have equal dimensions
All locations cells at one level have equal height
All locations cells at one level have equal width
All locations cells at one level have equal depth
All locations cells at one level have equal height×width dimensions
All locations cells at one level have equal height×depth dimensions
All locations cells at one level have equal depth×width dimensions
All cells are square or cube
All cells are rectangles of fixed sizes in dimensions
All cells at one level are same shape either cube or rectangle and optionally can have same one dimension
All cells at one level are of same dimensions
All space can be digitized or gridded into cells
All locations can be mapped onto cells
All locations can be classified as merchandisable or non-merchandisable cell units
No location can be occupied by more than one product unless, however one location can be made up of more than one cell and hence one product can be mapped to more than one cell
Logical locations increment irrespective of nulls or empty space which are null locations
All locations are tagged unique top to left and all the way down or with similar strategy.

One or more of the above relaxations, approximation, and assumptions create a variant of the base models dynamically inside the disclosed technology so as to either make optimization possible and easier, or to provide extra features from modeling capability or achieve improved performance in running models.

The disclosed techniques for making and using base models creates a minimalistic approach and with following assumptions to arrive at the most simple model.

### Example Space and Resource Optimization System

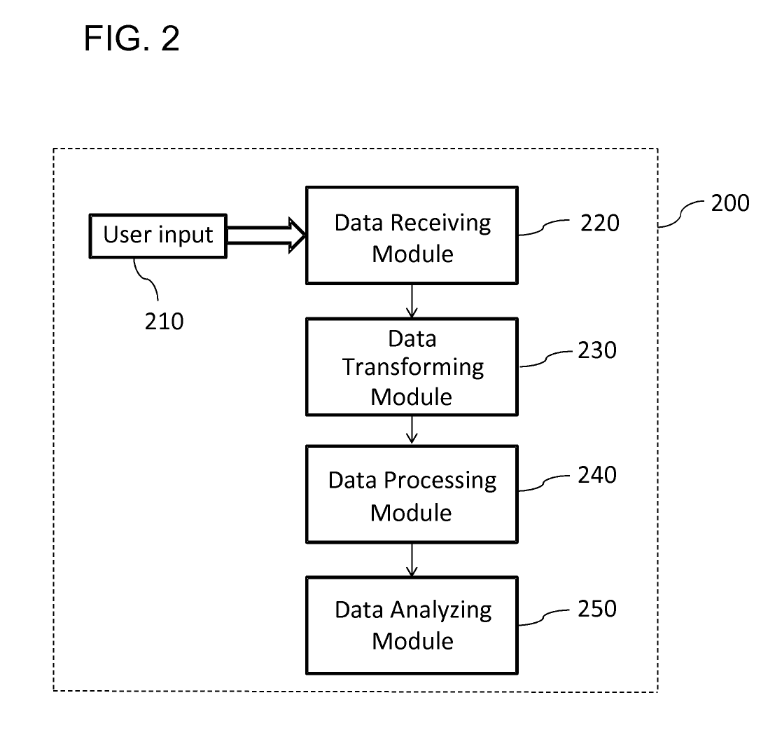

FIG. 2 is a block diagram illustrating a system 200 for space and resource optimization, in accordance with some examples of the disclosed technology. The system 200 comprises I/O functionality for receiving user input 210, a data receiving module 220, a data transforming module 230, a data processing module, 240 and a data analyzing module 250.

The data receiving module 220 is configured to receive a plurality of inputs (e.g., including user input 210). The plurality of inputs can be but not restricted to at least one dimension, a reference data, at least one hierarchy, or a plurality of user provided constraints. There can exist at least one hierarchy present inside each of the at least one dimension defined as an input.

The system 200 further comprises a data transforming module 230 communicably coupled to the data receiving module 220, wherein the data transforming module 230 is further configured to transform the plurality of inputs to one or more of an algorithmic graph or a structural graph. In this example, the plurality of inputs is transformed based on an algorithmic requirement or based on an internal application. The at least one hierarchy present inside at least one dimension is unfolded on a specified axis. Further, the plurality of data is encoded on the specific axis in an S-cell structure axis. The plurality of data on the specific axis in the s-cell structure axis can be solved. A plurality of decision variables can also be used while transforming the plurality of inputs. The plurality of decision variables can be a problem statement or an internal structure. Also, a plurality of constraints can be used for the step of transformation of the plurality of inputs. The plurality of constraints can be, but are not limited to, a plurality of relaxations, a plurality of approximations, and/or a plurality of assumptions. The act of transformation can also be performed using the plurality of user inputs, wherein the plurality of user inputs can be, but not restricted to, a set of domain specific rules or a set of domain independent rules. Transformation is performed at the higher level constraint type into lower levels ones by subsequent application for each higher level or extended constraint type into its relevant lower level constraints and then further converted into base or atomic constraints.

The system 200 further comprises a data processing module 240. The data processing module 240 is configured to receive input from the data transforming module 230 and perform an optimization run. In essence, when optimization runs, an optimal picture that is rendered is (nonlinear or linear multi-dimensional-multi objective) is point on part of the internal canvas representing optimality, that is, the internal Picture or structure equals transformations plus implicit-explicit domain specific and domain independent structural constraints plus explicit domain picture constraints plus implicit domain picture constraints, and the algorithm is mimicked by creating a structure inside optimization. The data processing module 240 is also configured to create heuristics for parallelization. The heuristics can be for both implicit and explicit parallelization.

The last component of the system 200 includes a data analyzing module 250 configured to analyze an optimal result received from the data processing module 240. The optimal result generated from the optimization run is analyzed. In the step of analyzing the optimal results from the optimization run, a set of decisions or at least one output dimension or an optimal result from the plurality of decision variables are generated in combination or individually. Furthermore, a post transformation or reverse transformation is performed after analyzing the optimal results. Transformation is specific to problem type and algorithm and is created as a picture of the source or target universe of feasible solutions, picture is made up of cells-like pixels, super-cell to organisms, or can evolve like stem cells into any definite organ where S-cells encode information with respect to dimensional data, hierarchical data, objective function data as a combined decision variable, and transforms the input to fit into that structure.

### Example Computing Environment

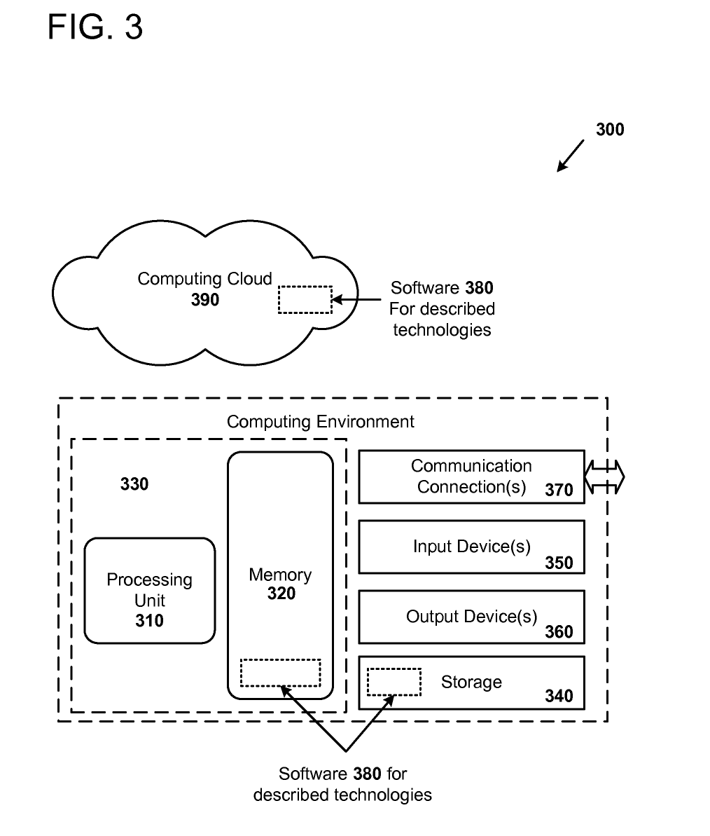

FIG. 3 illustrates a generalized example of a suitable computing environment 300 in which described embodiments, techniques, and technologies can be implemented. For example, the computing environment 300 can implement the disclosed systems and methods space and resource optimization as can be used in accordance with certain embodiments of the disclosed technology.

The computing environment 300 is not intended to suggest any limitation as to scope of use or functionality of the technology, as the technology can be implemented in diverse general-purpose or special-purpose computing environments. For example, the disclosed technology can be implemented with other computer system configurations, including hand held devices, multiprocessor systems, microprocessor-based or programmable consumer electronics, network PCs, minicomputers, mainframe computers, and the like. The disclosed technology can also be practiced in distributed computing environments where tasks are performed by remote processing devices that are linked through a communications network. In a distributed computing environment, program modules can be located in both local and remote memory storage devices.

With reference to FIG. 3, the computing environment 300 includes at least one central processing unit 310 and memory 320. In FIG. 3, this basic configuration 330 is included within a dashed line. The central processing unit 310 executes computer-executable instructions and can be a real or a virtual processor (e.g., which ultimately is executed on processor hardware). In a multi-processing system, multiple processing units execute computer-executable instructions to increase processing power and as such, multiple processors can be running simultaneously. The memory 320 can be volatile memory (e.g., registers, cache, RAM), non-volatile memory (e.g., ROM, EEPROM, flash memory, etc.), or some combination of the two. The memory 320 stores software 380 that can, for example, implement the technologies described herein. A computing environment can have additional features. For example, the computing environment 300 includes storage 340, one or more input devices 350, one or more output devices 360, and one or more communication connections 370. An interconnection mechanism (not shown) such as a bus, a controller, or a network, interconnects the components of the computing environment 300. Typically, operating system software (not shown) provides an operating environment for other software executing in the computing environment 300, and coordinates activities of the components of the computing environment 300.

The storage 340 can be removable or non-removable, and includes magnetic disks, magnetic tapes or cassettes, CD-ROMs, CD-RWs, DVDs, or any other medium which can be used to store information and that can be accessed within the computing environment 300. The storage 340 stores instructions for the software 380, which can implement technologies described herein.

The input device(s) 350 can be a touch input device, such as a keyboard, keypad, mouse, touch screen display, pen, or trackball, a voice input device, a scanning device, or another device, that provides input to the computing environment 300. For audio, the input device(s) 350 can be a sound card or similar device that accepts audio input in analog or digital form, or a CD-ROM reader that provides audio samples to the computing environment 300. The output device(s) 360 can be a display, printer, speaker, CD-writer, or another device that provides output from the computing environment 300.

The communication connection(s) 370 enable communication over a communication medium (e.g., a connecting network) to another computing entity. The communication medium conveys information such as computer-executable instructions, compressed graphics information, video, or other data in a modulated data signal.

Some embodiments of the disclosed methods can be performed using computer-executable instructions implementing all or a portion of the disclosed technology in a computing cloud 390. Space and resource optimization can be performed on servers located in the computing cloud 390.

Computer-readable media are any available media that can be accessed within a computing environment 300. By way of example, and not limitation, with the computing environment 300, computer-readable media include memory 320 and/or storage 340. As should be readily understood, the term computer-readable storage media includes the media for data storage such as memory 320 and storage 340, and not transmission media such as modulated data signals.

Any of the methods described herein can be performed via one or more computer-readable media (e.g., storage or other tangible media) comprising (e.g., having or storing) computer-executable instructions for performing (e.g., causing a computing device to perform) such methods. Operation can be fully automatic, semi-automatic, or involve manual intervention.

Any of the methods described herein can be implemented by computer-executable instructions stored in one or more computer-readable storage devices (e.g., memory, magnetic storage, optical storage, or the like). Such instructions can cause a computer to perform the method.

Having described and illustrated the principles of our innovations in the detailed description and accompanying drawings, it will be recognized that the various embodiments can be modified in arrangement and detail without departing from such principles. It should be understood that the programs, processes, or methods described herein are not related or limited to any particular type of computing environment, unless indicated otherwise. Various types of general purpose or specialized computing environments can be used with or perform operations in accordance with the teachings described herein. Elements of embodiments shown in software can be implemented in hardware and vice versa.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims and their equivalents.

We claim:

1. A method comprising:
receiving a plurality of inputs;
transforming the plurality of inputs into at least one or more of: an algorithmic graph, and a structural graph; and
with a processor:
creating heuristics for parallelization based on a domain-specific area,
performing an optimization run, and
analyzing an optimal result from the optimization run.

2. The method of claim 1, wherein the plurality of inputs comprises at least one or more of the following:
at least one dimension;
a reference data;
at least one hierarchy; or
a plurality of user provided constraints.

3. The method of claim 2, wherein the at least one hierarchy is present inside each of the at least one dimension.

4. The method of claim 1, wherein the act of transforming the plurality of inputs further comprises transforming the plurality of inputs based on an internal application.

5. The method of claim 1, wherein the act of transforming the plurality of inputs further comprises transforming the plurality of inputs based on an algorithmic requirement.

6. The method of claim 1, wherein the act of transforming the plurality of inputs further comprises unfolding the at least one hierarchy inside the least one dimension on a specific axis.

7. The method of claim 6, further comprises encoding a plurality of data on the specific axis in an S-cell structure axis.

8. The method of claim 7, further comprising solving the plurality of data on the specific axis in the s-cell structure axis.

9. The method of claim 1, wherein the act of transforming the plurality of inputs further comprises defining a plurality of decision variables appropriately based on:
a problem statement; and
an internal structure.

10. The method of claim 1, wherein the act of transforming the plurality of inputs further comprises using a plurality of constraints, wherein the plurality of constraints comprises at least one or more of the following:
a plurality of relaxations;
a plurality of approximations; or
a plurality of assumptions.

11. The method of claim 1, further comprising performing structural simplifications.

12. The method of claim 1, wherein the act of transforming the plurality of inputs further comprises creating an implicit constraint to enforce the structural limitations.

13. The method of claim 1, wherein the act of transforming the plurality of inputs further comprises accepting a plurality of user inputs.

14. The method of claim 13, wherein the plurality of user inputs comprises at least one or more of the following:
a set of domain specific rules; or
a set of domain independent rules.

15. The method of claim 1, wherein the act of creating heuristics for parallelization further comprises creating heuristics for:
implicit parallelization; and
explicit parallelization.

16. The method of claim 1, further comprising generating a dynamic model from a plurality of objectives, wherein the plurality of objectives comprises at least one or more of the following:
a single objective; or
a multiple objective.

17. The method of claim 1, further comprising performing at least one or more of the following acts:
generating at least one implicit constraint file; or
generating at least one explicit constraint file.

18. The method of claim 1, wherein the analyzing the optimal results from the optimization run further comprises generating at least one or more of the following:
a set of decisions;
at least one output dimensions; or
an optimal result from the plurality of decision variables.

19. The method of claim 18, further comprising performing at least one or more of the following:
a post transformation; or
a reverse transformation.

20. One or more computer-readable storage media storing computer-readable instructions that when executed by a computer, cause the computer to perform the method of claim 1.

21. A system comprising:
a data receiving module configured to receive a plurality of inputs;
a data transforming module communicably coupled to the data receiving module, the data transforming module further configured to transform the plurality of inputs to at least one or more of: an algorithmic graph, and a structural graph;
a data processing module configured to receive input from the data transforming module and perform an optimization run; and
a data analyzing module configured to analyze an optimal result received from the data processing module.

22. The system of claim 21, wherein the plurality of inputs comprises at least one or more of the following:
at least one dimension;
a reference data;
at least one hierarchy; or
a plurality of user provided constraints.

23. The system of claim 21, wherein the data transforming module is further configured to transform the plurality of inputs based on at least one or more of the following:
an internal application; or
an algorithmic requirement.

24. The system of claim 21, wherein the at least one hierarchy is present in each of the at least one dimensions.

25. The system of claim 21, wherein the data transforming module is further configured to unfold the at least one hierarchy inside the least one dimension on a specific axis and encode a plurality of data on the specific axis in an S-cell structure axis.

26. The system of claim 25, wherein the data transforming module is configured to solve the plurality of data on the specific axis in the S-cell structure axis.

27. The system of claim 21, wherein the data transforming module is configured to define a plurality of decision variables based on at least one or more of the following:
a problem statement; or
an internal structure.

28. The system of claim 21, wherein the plurality of inputs are transformed using a plurality of constraints, wherein the plurality of constraints comprises at least one or more of the following:
a plurality of relaxations;
a plurality of approximations; or
a plurality of assumptions.

29. The system of claim 28, wherein the plurality of constraints comprises at least one or more of the following:
a plurality of items selected from the group;
at least two of the plurality of items together; or
a plurality of items selected with lesser facings.

30. The system of claim 29, wherein the plurality of assumptions can include at least one or more of the following:
rotations of the products inside the shelf;
a single objective function in rank and profit;
a simple linear objective;
a shelf width as equal; or
a shelf and section/fixture as a rectangular entity.

31. The system of claim 21, wherein the data transforming module is configured to perform at least one or more of the following acts:
creating heuristics for implicit parallelization and creating heuristics for explicit parallelization;
performing structural simplifications; or
creating an implicit constraint to enforce a structural limitations.

32. The system of claim 21, wherein the data transforming module is configured to receive a plurality of user inputs, wherein the plurality of user inputs comprises at least one or more of the following:
a set of domain specific rules; or
a set of domain independent rules.

33. The system of claim 21, wherein the data processing module is configured to generate a dynamic model from a plurality of objectives, wherein the plurality of objectives includes at least one or more of the following:
a single objective; or
a multiple objective.

34. The system of claim 21, wherein the data transforming module is configured to perform at least one or more of the following acts:
generating at least one implicit constraint file; or
generating at least one explicit constraint file.

35. The system of claim 21, wherein the data analyzing module is further configured to analyze the optimal results from the optimization run, and wherein the analyzing the optimal results further comprises generating at least one or more of the following:
a set of decisions;
at least one output dimensions; or
an optimal result from the plurality of decision variables.

36. The system of claim 35, wherein the data analyzing module is further configured to perform at least one or more of the following transformations:
a post transformation; or
a reverse transformation.

37. The system of claim 21, wherein the data processing module can be configured to reduce the optimization to a knapsack algorithm by accepting data representing at least one or more of the following data:
assortment;
pricing;
budget;
supply chain replenishment rules; or
case pack size to determine facings.
